(19) United States
(12) Patent Application Publication
(10) Pub. No.: US 2015/0315309 A1
(43) Pub. Date: Nov. 5, 2015

(54) PROCESS FOR PREPARING FUNCTIONALIZED POLYISOBUTENES AND DERIVATIVES THEREOF

(71) Applicant: BASF SE, Ludwigshafen (DE)

(72) Inventors: Arno LANGE, Bad Duerkheim (DE); Szilard CSIHONY, Gorxheimertal (DE); Matthias KLEINER, Goennheim (DE)

(21) Appl. No.: 14/648,165

(22) PCT Filed: Dec. 5, 2013
(86) PCT No.: PCT/EP13/75618

§ 371 Date: May 28, 2015

Related U.S. Application Data
(60) Provisional application No. 61/735,075, filed on Dec. 10, 2012.

(30) Foreign Application Priority Data
Dec. 10, 2012 (EP) 12196265.8

(51) Int. Cl. C08F 110/10; C08G 81/02

(52) U.S. Cl. CPC C08F 110/10; C08G 81/025

(57) ABSTRACT

What is described is a process for preparing functionalized polyisobutenes, in which isobutene or an isobutene-containing monomer mixture is polymerized in the presence of a Lewis acid and of an initiator, and the polymerization is terminated with a mixture of a phenol and a Lewis acid and/or a Brønsted acid. The terminal phenol groups can be derivatized or reduced to cyclohexanol systems.

The present invention relates to a process for preparing functionalized polyisobutenes and to the functionalized polyisobutenes obtainable by the process and to the use thereof.

Homo- and copolymers of isobutene find various uses, for example for production of fuel additives and lubricant additives, as elastomers, as adhesives or adhesive raw materials, or as a base constituent of sealing compounds.

The preparation of polyisobutenes (PIBs) by living cationic polymerization of isobutene is known. Living cationic polymerization generally refers to the polymerization of isoolefins or vinylaromatics in the presence of metal halides or semimetal halides as Lewis acid catalysts, and of tert-alkyl, benzyl or allyl halides, benzyl or allyl esters or benzyl or allyl ethers as initiators, which form a carbocation or a cationogenic complex with the Lewis acid. A comprehensive overview thereof can be found in Kennedy/Ivan, “Carbocationic Macromolecular Engineering”, Hauser Publishers 1992.

One advantage of living cationic polymerization is that polyisobutenes having relatively narrow molecular weight distributions are obtained. However, in-house experiments have shown that the application of the known prior art processes to the polymerization of isobutene to give polyisobutenes of moderate molecular weight, i.e. to give polyisobutenes having a number-average molecular weight Mn of 300 to 30 000, in particular 2000 to 20 000, especially of 3000 to 16 000 and specifically of 5000 to 11 000, does not lead to a sufficiently narrow molecular weight distribution. This is the case particularly when polymerization conditions of economic interest are employed, for example when, rather than boron trichloride, which is costly and gaseous at room temperature, titanium tetrachloride, which is less expensive and easier to handle, is used.

Polyisobutenes terminated by at least one —OH function are valuable intermediates for preparation of macromers (acrylates, epoxides, allyl ethers) or polymers (polyurethanes). The achievement of Kennedy and Ivan was to be the first to have published a synthesis route to such compounds via borane addition (Ivan, Kennedy, Chang; J. Polym. Sci. Polym. Chem. Ed. 18, 3177 (1980)). Without wishing to doubt the reproducibility of the Kennedy data in an industrial chemistry laboratory, however, it may be pointed out here that the use of boranes is too costly and inconvenient for preparation of industrial polymers.

It is additionally known that phenol-terminated polyisobutenes can be prepared. For this purpose, to date, according to literature information (e.g.: Nguyen and Marechal, Polym. Bull. 11, p. 99-104 (1984), U.S. Pat. No. 4,429,099 (1984), U.S. Pat. No. 5,300,701 (1994)) and in-house experiments by the applicant, a three-stage process was necessary:

1. polymerization of the isobutene and termination, for example with alcohols
2. dehydrohalogenation of the Cl-terminated polymers obtained to give the olefins
3. reaction with phenol to give the polyisobutenylphenols

These steps are laborious and lead to complex, multistage processes which are undesirable especially in industrial practice. Moreover, the product quality deteriorates through dimerization in the termination reaction 1, while the unwanted partial formation of internal (tetrasubstituted) olefins which are no longer reactive has to be expected in steps 2 and 3.

Especially for the use of functionalized PIB, and of PIB derivatized with reactive groups at the functional groups, in adhesives or as a macromer in adhesives, PIBs of high molecular weight Mn are of interest, in order to improve the desired use properties (adhesive properties, mechanical properties, elasticity, barrier effects) by virtue of an elevated PIB content.

It was therefore an object of the present invention to provide a simple process with which phenol-functionalized and particularly bi- and polyfunctional polyisobutenes having narrow molecular weight distribution (i.e. having a minimum PDI value; PDI=Mw/Mn; Mw=weight-average molecular weight, Mn=number-average molecular weight), maximum molecular weight Mn and maximum functionality (for example very close to a functionality of 100%) are obtainable without complex further reactions.

It was surprising that suitable process conditions and catalysts can be used to combine the abovementioned process steps 1 to 3, and polyisobutenylphenols which achieve the object can be prepared using otherwise industrially standard processes and materials.

The object is achieved by the process described in detail hereinafter.

The present invention provides a process for preparing functionalized polyisobutenes, in which isobutene or an isobutene-containing monomer mixture is polymerized in the presence of a Lewis acid and of an initiator and the polymerization is terminated with a mixture of at least one phenol and at least one Lewis acid and/or at least one Brønsted acid and the terminal phenol groups are optionally derivatized or reduced to cyclohexanol systems.

By virtue of the process according to the invention, isobutene polymers comprising phenol groups at the chain end(s) are obtainable. According to the objects, the terminal phenol groups can also be derivatized, for example esterified or etherified, and converted, for example reduced to cyclohexanol systems.

The invention also provides polyisobutenes obtainable by the process according to the invention.

The invention also provides for the use of polyisobutenes obtainable by the process according to the invention for production of adhesives, adhesive raw materials, fuel additives, lubricant additives, as elastomers or as base constituent of sealing compounds.

The term “(meth)acrylate” and similar terms are used hereinafter as abbreviated notation for “acrylate or methacrylate”.

Hereinafter, polyisobutenes are also understood to mean copolymers where the proportion of isobutene in the total amount of monomers is more than 50% by weight, preferably more than 80% by weight.

Hereinafter, “derivatized” or “derivatives” is understood to mean that, rather than the hydrogen atom of the OH group of at least one of the terminal phenol groups, another atom or another atom group is present.

The initiator is an organic compound having at least one functional group FG which can form a carbocation or a cationogenic complex with the Lewis acid under polymerization conditions. The terms “carbocation” and “cationogenic complex” are not strictly separated from one another, but comprise all intermediate stages of solvent-separated ions, solvent-separated ion pairs, contact ion pairs and strongly polarized complexes with a positive partial charge on a carbon atom of the initiator molecule, and the latter species in particular are probably present.

Suitable initiators are in principle all organic compounds which have at least one nucleophilically displaceable leaving group X and which can stabilize a positive charge or partial charge on the carbon atom which bears the leaving group X. These are known to include compounds having at least one leaving group X bonded to a secondary or tertiary aliphatic carbon atom or to an allylic or benzylic carbon atom. Useful leaving groups include halogen, alkoxy, preferably C₁-C₆-alkoxy, and acyloxy (alkylcarbonyloxy), preferably C₁-C₆-alkylcarbonyloxy.

Halogen here represents especially chlorine, bromine or iodine and specifically chlorine. C₁-C₆-Alkoxy may be either linear or branched, and is, for example, methoxy, ethoxy, n-propoxy, isopropoxy, n-butoxy, isobutoxy, n-pentoxy and n-hexoxy, especially methoxy. C₁-C₆-Alkylcarbonyloxy is, for example, acetoxy, propionyloxy, n-butyroxy and isobutyroxy, especially acetoxy.

Preference is given to those initiators in which the functional group has the general formula FG

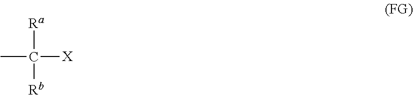

in which
X is selected from halogen, C₁-C₆-alkoxy and C₁-C₆-acyloxy,
R^{a} is hydrogen or methyl and
R^{b} is methyl or forms a C₅-C₆-cycloalkyl ring with R^{a} or the molecular moiety to which the functional group FG is bonded, and R^{b} may also be hydrogen when the functional group FG is bonded to an aromatic or olefinically unsaturated carbon atom.

The initiators preferably have one, two, three or four and particularly one or two functional groups FG, and specifically one functional group FG. Preferably, X in formula (FG) is a halogen atom, especially chlorine.

Preferred initiators obey, for example, the general formulae I-A to I-F:

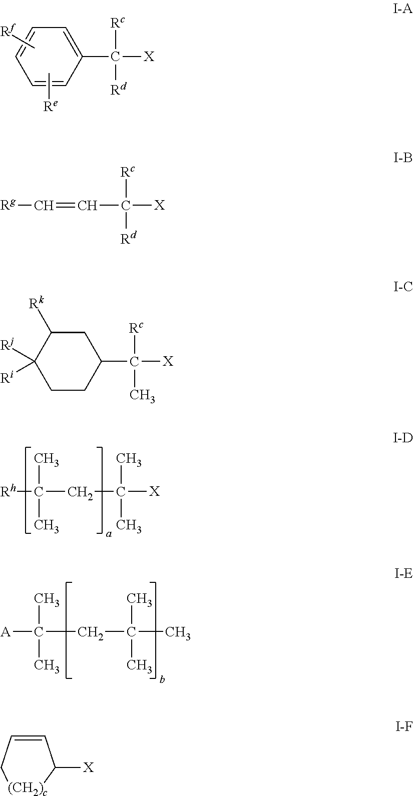

in which X is as defined above;
a and b are each independently 0, 1, 2, 3, 4 or 5;
c is 1, 2 or 3;
R^{c}, R^{d} and R^{j} are each independently hydrogen or methyl;
R^{e}, R^{f} and R^{g} are each independently hydrogen, C₁-C₄-alkyl or a CR^{c}R^{d}—X group in which R^{c}, R^{d} and X are each as defined above;
R^{h} is hydrogen, methyl or an X group;
Rⁱ and R^{k} are each hydrogen or an X group; and
A is an ethylenically unsaturated hydrocarbonyl radical having a vinyl group or a cycloalkenyl group.

In the formulae I-A to I-C, R^{e} and R^{d} are preferably both methyl. In the formula I-A, R^{f} is, for example, a CR^{c}Rd⁴-X group arranged in the para or meta position to the CR^{c}R^{d}X-group, especially when R^{e} is hydrogen. It may also be in the meta position when the R^{e} group is C₁-C₄-alkyl or a CR^{c}R^{d}—X group. Preferred compounds I-A are, for example: 2-chloro-2-phenylpropane and 1,4-bis(2-chloro-2-propyl)benzene (1,4-dicumyl chloride, 1,4-DCC) or 1,3-bis(2-chloro-2-propyl)benzene (1,3-dicumyl chloride, 1,3-DCC).

Examples of compounds of the formula I-B are allyl chloride, methallyl chloride, 2-chloro-2-methyl-2-butene and 2,5-dichloro-2,5-dimethyl-3-hexene.

In the compounds I-C, R^{c} is preferably methyl. Rⁱ is preferably an X group, and especially halogen, especially when R^{j} is methyl.

Examples of compounds of the general formula I-C are 1,8-dichloro-4-p-menthane (limonene dihydrochloride), 1,8-dibromo-4-p-menthane (limonene dihydrobromide), 1-(1-chloroethyl-3-chlorocyclohexane, 1-(1-chloroethyl-4-chlorocyclohexane, 1-(1-bromoethyl)-3-bromocyclohexane and 1-(1-bromoethyl)-4-bromocyclohexane.

Among the compounds of the formula I-D preference is given to those in which R^{h} is a methyl group. Preference is also given to compounds of the general formula I-D in which R^{h} is an X group, and especially a halogen atom, when a>0.

In compounds I-E, A is a hydrocarbonyl radical having generally 2 to 21 carbon atoms, which has either a vinyl group (CH₂═CH—) or a C₅-C₈-cycloalkenyl radical, e.g. cyclopenten-3-yl, cyclopenten-4-yl, cyclohexen-3-yl, cyclohexen-4-yl, cyclohepten-3-yl, cyclohepten-4-yl, cycloocten-3-yl, cycloocten-4-yl or cycloocten-5-yl.

Preferably, A is a radical of the formula A.1, A.2 or A.3

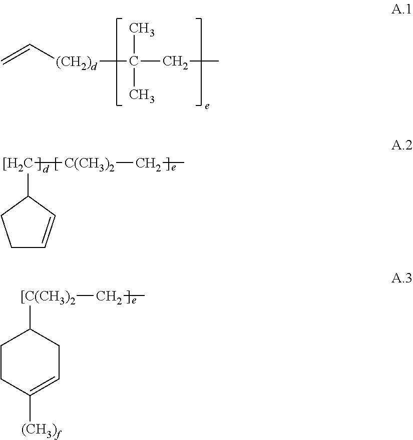

in which
d is 0 or 1;
e is a number from 0 to 3, especially 0, 1 or 2, and
f is 0 or 1.

In compounds I-E where A=A.2, d is preferably 1.

In compounds I-E where A=A.3, e is preferably 0. f is preferably 1. Examples of initiator compounds I-E are 2-chloro-2-methyl-3-butene, 2-chloro-2-methyl-4-pentene, 2-chloro-2,4,4-trimethyl-5-hexene, 2-chloro-2-methyl-3-(cyclopenten-3-yl)propane, 2-chloro-2-methyl-4-(cyclohexen-4-yl)pentane and 2-chloro-2-(1-methylcyclohexen-4-yl)propene.

In compounds of the formula I-F, X is preferably chlorine. c is preferably 1 or 2 and more preferably 1. A preferred compound of the formula I-F is 3-chlorocyclopentene.

Particular preference is given to using initiators of the formula I-A or I-D and especially those of the formula I-D.

The above-described initiators and processes for preparation thereof are known and are described, for example, in WO 02/48215, WO 03/074577 and WO 2004/113402, which are hereby fully incorporated by reference.

Useful Lewis acids for triggering the polymerization include covalent metal halides and semimetal halides which have a vacancy for an electron pair. Such compounds are known to those skilled in the art, for example from J. P. Kennedy et al. in U.S. Pat. No. 4,946,889, U.S. Pat. No. 4,327,201, U.S. Pat. No. 5,169,914, EP-A 206 756, EP-A 265 053, and also comprehensively in J. P. Kennedy, B. Ivan, “Designed Polymers by Carbocationic Macromolecular Engineering”, Oxford University Press, New York, 1991. They are generally selected from halogen compounds of titanium, of tin, of aluminum, of vanadium or of iron, and also the halides of boron. Preference is given to the chlorides, and in the case of aluminum also to the monoalkylaluminum dichlorides and the dialkylaluminum chlorides. Preferred Lewis acids are titanium tetrachloride, boron trichloride, boron trifluoride, tin tetrachloride, aluminum trichloride, vanadium pentachloride, iron trichloride, alkylaluminum dichlorides and dialkylaluminum chlorides. Particularly preferred Lewis acids are titanium tetrachloride, boron trichloride and boron trifluoride, and especially titanium tetrachloride.

It has been found to be useful to perform the polymerization in the presence of an electron donor. Useful electron donors include aprotic organic compounds which have a free electron pair on a nitrogen, oxygen or sulfur atom. Preferred donor compounds are selected from pyridines such as pyridine itself, 2,6-dimethylpyridine, and also sterically hindered pyridines such as 2,6-diisopropylpyridine and 2,6-di-tert-butylpyridine; amides, especially N,N-dialkylamides of aliphatic and aromatic carboxylic acids such as N,N-dimethylacetamide; lactams, especially N-alkyllactams such as N-methylpyrrolidone; ethers, for example dialkyl ethers such as diethyl ether and diisopropyl ether, cyclic ethers such as tetrahydrofuran; amines, especially trialkylamines such as triethylamine; esters, especially C₁-C₄-alkyl esters of aliphatic C₁-C₆-carboxylic acids, such as ethyl acetate; thioethers, especially dialkyl thioethers or alkylaryl thioethers, such as methyl phenyl sulfide; sulfoxides, especially dialkyl sulfoxides, such as dimethyl sulfoxide; nitriles, especially alkyl nitriles such as acetonitrile and propionitrile; phosphines, especially trialkylphosphines or triarylphosphines, such as trimethylphosphine, triethylphosphine, tri-n-butylphosphine and triphenylphosphine, and unpolymerizable aprotic organosilicon compounds which have at least one organic radical bonded via oxygen.

Among the aforementioned donors, preference is given to pyridine and sterically hindered pyridine derivatives and especially to organosilicon compounds.

Preferred organosilicon compounds of this type are those of the general formula VI:

R^{a}ᵣSi(OR^{b})₄₋ᵣ (VI)

in which r is 1, 2 or 3,
R^{a} may be the same or different and are each independently C₁-C₂₀-alkyl, C₃-C₇-cycloalkyl, aryl or aryl-C₁-C₄-alkyl, where the three latter radicals may also have one or more C₁-C₁₀-alkyl groups as substituents, and
R^{b} are the same or different and are each C₁-C₂₀-alkyl, or, in the case that r is 1 or 2, two R^{b} radicals together may be alkylene.

In the formula VI, r is preferably 1 or 2. R^{a} is preferably a C₁-C₈-alkyl group, and especially a branched alkyl group or an alkyl group bonded via a secondary carbon atom, such as isopropyl, isobutyl, sec-butyl, or a 5-, 6- or 7-membered cycloalkyl group, or an aryl group, especially phenyl. The variable R^{b} is preferably a C₁-C₄-alkyl group, or a phenyl, tolyl or benzyl radical.

Examples of preferred compounds of this type are dimethoxydiisopropylsilane, dimethoxyisobutylisopropylsilane, dimethoxydiisobutylsilane, dimethoxydicyclopentylsilane, dimethoxyisobutyl-2-butylsilane, diethoxyisobutylisopropylsilane, triethoxytolylsilane, triethoxybenzylsilane and triethoxyphenylsilane.

In the context of the present invention, C₁-C₄-alkyl represents a branched or linear alkyl radical, such as methyl, ethyl, propyl, isopropyl, n-butyl, sec-butyl, isobutyl or tert-butyl. C₁-C₈-Alkyl is additionally pentyl, hexyl, heptyl, octyl and the positional isomers thereof. C₁-C₂₀-Alkyl is additionally nonyl, decyl, undecyl, dodecyl, tridecyl, tetradecyl, pentadecyl, hexadecyl, heptadecyl, octadecyl, nonadecyl, eicosyl and the positional isomers thereof.

C₃-C₇-Cycloalkyl is, for example, cyclopropyl, cyclopentyl, cyclohexyl, cycloheptyl and cyclooctyl.

Aryl is especially phenyl, naphthyl or tolyl.

Aryl-C₁-C₄-alkyl is especially benzyl or 2-phenylethyl.

Alkylene is, for example, C₂-C₅-alkylene such as 1,2-ethylene, 1,2- and 1,3-propylene, 1,4-butylene and 1,5-pentylene.

The Lewis acid is used in an amount sufficient to form the initiator complex. The molar ratio of Lewis acid to initiator compound I is generally 10:1 to 1:10, particularly 1:1 to 1:4 and especially 1:1 to 1:2.5.

The Lewis acid and the electron donor are preferably used in a molar ratio of 20:1 to 1:20, more preferably of 5:1 to 1:5 and especially of 2:1 to 1:2.

The concentration of Lewis acid in the reaction mixture is typically in the range from 0.1 to 200 g/l and especially in the range from 1 to 50 g/l.

Suitable isobutene feedstocks of the process according to the invention are both isobutene itself and isobutene-containing C₄ hydrocarbon streams, for example C₄ raffinates, C₄ cuts from isobutene dehydrogenation, C₄ cuts from steamcrackers, FCC crackers (FCC: Fluid Catalyzed Cracking), provided that they have been substantially freed of 1,3-butadiene present therein. C₄ hydrocarbon streams suitable in accordance with the invention comprise generally less than 500 ppm, preferably less than 200 ppm, of butadiene. In the case of use of C₄ cuts as starting material, the hydrocarbons other than isobutene assume the role of an inert solvent.

It is also possible to react monomer mixtures of isobutene with olefinically unsaturated monomers copolymerizable with isobutene under cationic polymerization conditions. The process according to the invention is also suitable for block copolymerization of isobutene with ethylenically unsaturated comonomers polymerizable under cationic polymerization conditions. If monomer mixtures of isobutene with suitable comonomers are to be copolymerized, the monomer mixture comprises preferably more than 80% by weight, especially more than 90% by weight and more preferably more than 95% by weight of isobutene, and less than 20% by weight, preferably less than 10% by weight and especially less than 5% by weight of comonomers.

Useful copolymerizable monomers include vinylaromatics such as styrene and α-methylstyrene, C₁-C₄-alkylstyrenes such as 2-, 3- and 4-methylstyrene, and also 4-tert-butylstyrene, isoolefines having 5 to 10 carbon atoms such as 2-methyl-1-butene, 2-methyl-1-pentene, 2-methyl-1-hexene, 2-ethyl-1-pentene, 2-ethyl-1-hexene and 2-propyl-1-heptene. Useful comonomers additionally include olefins having a silyl group, such as 1-trimethoxysilylethene, 1-(trimethoxysilyl)propene, 1-(trimethoxysilyl)-2-methyl-2-propene, 1-[tri(methoxyethoxy)silyl]ethene, 1-[tri(methoxyethoxy)silyl]propene, and 1-[tri(methoxyethoxy)silyl]-2-methyl-2-propene.

The polymerization is typically performed in a solvent. Useful solvents include all low molecular weight organic compounds or mixtures thereof which have a suitable dielectric constant and no abstractable protons and which are liquid under the polymerization conditions. Preferred solvents are hydrocarbons, for example acyclic hydrocarbons having 2 to 8 and preferably 3 to 8 carbon atoms, such as ethane, iso- and n-propane, n-butane and isomers thereof, n-pentane and isomers thereof, n-hexane and isomers thereof, n-heptane and isomers thereof, and n-octane and isomers thereof, cyclic alkanes having 5 to 8 carbon atoms, such as cyclopentane, methylcyclopentane, cyclohexane, methylcyclohexane, cycloheptane, acyclic alkenes having preferably 2 to 8 carbon atoms, such as ethene, iso- and n-propene, n-butene, n-pentene, n-hexene and n-heptene, cyclic olefins such as cyclopentene, cyclohexene and cycloheptene, aromatic hydrocarbons such as toluene, xylene, ethylbenzene, and halogenated hydrocarbons such as halogenated aliphatic hydrocarbons, for example such as chloromethane, dichloromethane, trichloromethane, chloroethane, 1,2-dichloroethane and 1,1,1-trichloroethane and 1-chlorobutane, and also halogenated aromatic hydrocarbons such as chlorobenzene and fluorobenzene. The halogenated hydrocarbons used as solvents do not comprise any compounds in which halogen atoms are present on secondary or tertiary carbon atoms.

Preferred solvents are aromatic hydrocarbons, among which toluene is particularly preferred. Likewise preferred are solvent mixtures comprising at least one halogenated hydrocarbon and at least one aliphatic or aromatic hydrocarbon. More particularly, the solvent mixture comprises hexane and chloromethane and/or dichloromethane. The volume ratio of hydrocarbon to halogenated hydrocarbon is preferably in the range from 1:10 to 10:1, more preferably in the range from 4:1 to 1:4 and especially in the range from 2:1 to 1:2.

Preference is also given to chlorinated hydrocarbons whose polarity allows polymerization in a homogeneous solvent. Examples are the propyl, butyl and pentyl chlorides, such as 1-chlorobutane and 2-chloropropane.

In general, the process according to the invention will be performed at temperatures below 0° C., for example in the range from 0 to −140° C., preferably in the range from −30 to −120° C. and more preferably in the range from −40 to −110° C., i.e. at about −45° C., about −50° C. or in the range of −30° C.-−80° C. A range from 0 to −30° C. can be achieved by means of standard ammonia cooling and is therefore particularly simple to achieve and particularly preferred. The reaction pressure is of minor importance.

The heat of reaction is removed in a customary manner, for example by wall cooling and/or with exploitation of evaporative cooling.

To terminate the reaction, the living chain ends are deactivated by addition of a mixture of at least one phenol (I) and at least one Lewis acid and/or at least one Brønsted acid.

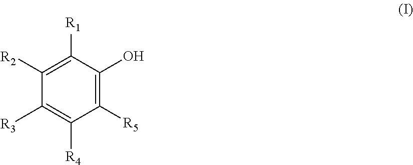

In which R₁, R₂, R₃, R₄, R₅ are the same or different and are each hydrogen, alkyl or alkoxy, with the proviso that at least one radical in an ortho or para position is hydrogen.

When one or more of the R₁, R₂, R₃, R₄, R₅ radicals are alkyl, this is a saturated, cyclic, linear or branched hydrocarbyl radical which typically has 1 to 20, frequently 1 to 10 and especially 1 to 4 carbon atoms and which is, for example, methyl, ethyl, n-propyl, isopropyl, n-butyl, sec-butyl, isobutyl, tert-butyl, n-pentyl, 2-pentyl, 3-pentyl, 2-methylbutyl, 3-methylbutyl, 3-methylbut-2-yl, 2-methylbut-2-yl, 2,2-dimethylpropyl, n-hexyl, 2-hexyl, 3-hexyl, 2-methylpentyl, 2-methylpent-3-yl, 2-methylpent-2-yl, 2-methylpent-4-yl, 3-methylpent-2-yl, 3-methylpent-3-yl, 3-methylpentyl, 2,2-dimethylbutyl, 2,2-dimethylbut-3-yl, 2,3-dimethylbut-2-yl, or 2,3-dimethylbutyl.

When one or more of the R₁, R₂, R₃, R₄, R₅ radicals are alkoxy, it is a saturated, cyclic, linear or branched hydrocarbyl radical which has typically 1 to 20, frequently 1 to 10 and especially 1 to 4 carbon atoms and is bonded to the phenol ring via an oxygen atom. Examples are the abovementioned hydrocarbyl radicals joined by an oxygen atom.

Useful Lewis acids include the Lewis acids described above for the polymerization, and forms such as BF₃, BCl₃, SnCl₄, TiCl₄, AlCl₃ are industrially readily obtainable and thus advantageous. With Al-containing Lewis acids, high conversions are obtained, and AlCl₃ is particularly preferred.

Useful Brønsted acids include strong organic acids or superacids, for example trifluoromethanesulfonic acid, methanesulfonic acid, trifluoroacetic acid, trichloroacetic acid.

The mixture can also be used in a solvent. For the selection thereof, the considerations made for the solvent in the polymerization apply. Preferred, particularly simple processes are arrived at when the same solvent is used for the polymerization and the termination mixture.

After the termination, the solvent is generally removed in suitable units such as rotary evaporators, falling-film evaporators or thin-film evaporators, or by decompression of the reaction solution, or further conversions are conducted in the same solvent.

In one embodiment of the process according to the invention, the polymerization is performed batchwise, i.e. as a batch reaction. For this purpose, for example, isobutene can be initially charged in a solvent, initiator and optionally further additions such as siloxanes can be added, and the reaction can be started with a Lewis acid. It is likewise possible to initially charge solvent, initiator, Lewis acid and optionally further additions such as siloxanes, and to control the reaction by continuous addition of isobutene. In all cases, the reaction temperature will be kept within the desired range by suitable cooling measures. A particular challenge in the polymerization arises from the high heat of reaction obtained within a short period. Part of the object of the present invention was therefore to provide a process which permits control of the rapid release of heat from the reaction. Especially polymerizations conducted on the industrial scale, given relatively large amounts converted, constitute a challenge in terms of the rapid heat release which occurs. Part of the object of the invention was therefore to provide a process which permits performance of reactions on the industrial scale.

In order to achieve relatively high molecular weights in a living cationic polymerization, it is necessary to achieve good temperature control via the removal of heat in continuous polymerization processes.

Accordingly, reactors having high heat transfer areas based on the reaction volume are an option. These may, as well as tubular reactors, also be reactors having rectangular channels, stirred tank reactors or particular micro- or milli-reactors. Micro- or milli-reactors allow good temperature control even in the case of strongly exothermic reactions. By virtue of the relatively large ratio of surface area to reactor volume, for example, very good heat supply and removal is enabled, and even strongly exothermic reactions can therefore be performed virtually isothermally. In addition, especially milli-reactors, due to their design, have good upscalability to the industrial scale.

In another embodiment of the process according to the invention, the polymerization is performed in a continuous process comprising at least the following steps:
(I) continuous metered addition of isobutene, solvent, initiator and optionally further additions to a mixer and mixing of the reactants in the mixing unit, and
(II) starting the continuous polymerization by continuous metered addition of a Lewis acid and mixing with the reactants at reaction temperature, and
(III) continuous polymerization by passing the resulting reaction mixture through at least one reaction zone under reaction conditions, and
(IV) terminating the reaction by means of a mixture of at least one phenol and at least one Lewis acid and/or at least one Brønsted acid.

In continuous mode, it is possible to adjust the reaction conditions after the initial addition of catalyst by metered addition of a further substance or of a substance mixture. For example, it is possible first to convert the initiator to the cationic complex and then to establish the conditions for the polymerization by addition of solvent and/or catalyst and/or cocatalyst and/or monomer.

Apparatus used:

The polymerization is preferably performed using milli-reactors. Milli-reactors differ from conventional apparatus by the characteristic dimension thereof. The characteristic dimension of a flow device, for example of a mixer or reactor, is understood in the context of the present invention to mean the smallest dimension at right angles to the flow direction. The characteristic dimension of milli-reactors is much smaller than that of conventional apparatus. It may especially be in the millimeter range. Compared to conventional reactors, milli-reactors therefore exhibit significantly different behavior in relation to the heat and mass transfer operations which proceed. By virtue of the relatively large ratio of surface area to reactor volume, for example, very good heat supply and removal is achieved, and even strongly endo- or exothermic reactions can therefore be performed virtually isothermally. Compared to micro-reactors, the characteristic dimensions of which are in the micrometer range, milli-reactors are less prone to blockage owing to the characteristic dimensions and thus have higher robustness with regard to industrial use.

Conventional reactors have a characteristic dimension of >30 mm, as opposed to ≧30 mm for milli-reactors. The characteristic dimension of a milli-reactor is generally at most 30 mm, for example 0.1 to 30 mm or preferably 0.3 to 30 mm or more preferably 0.5 to 30 mm; preferably at most 20 mm, for example 0.1 to 20 mm or preferably 0.3 to 20 mm or more preferably 0.5 to 20 mm; more preferably at most 15 mm, for example 0.1 to 15 mm, or preferably 0.3 to 15 mm or more preferably 0.5 to 15 mm; even more preferably at most 10 mm, for example 0.1 to 10 mm or preferably 0.3 to 10 mm or more preferably 0.5 to 10 mm; even more preferably still at most 8 mm, for example 0.1 to 8 mm or preferably 0.3 to 8 mm or more preferably 0.5 to 8 mm; particularly at most 6 mm, for example 0.1 to 6 mm or preferably 0.3 to 6 mm or more preferably 0.5 to 6 mm; and especially at most 4 mm, for example 0.1 to 4 mm or preferably 0.3 to 4 mm or more preferably 0.5 to 4 mm.

Milli-reactors for use in accordance with the invention are preferably selected from temperature-controllable tubular reactors, shell and tube heat exchangers, plate heat exchangers and temperature-controllable tubular reactors with internals. Tubular reactors, shell and tube heat exchangers and plate heat exchangers for use in accordance with the invention have, as characteristic dimensions, tube or capillary diameters in the range from preferably 0.1 mm to 25 mm, more preferably in the range from 0.5 mm to 6 mm, even more preferably in the range from 0.7 to 5 mm and especially in the range from 0.8 mm to 4 mm, and layer heights or channel widths in the range from preferably 0.2 mm to 10 mm, more preferably in the range from 0.2 mm to 6 mm and especially in the range from 0.2 mm to 4 mm. Tubular reactors having internals for use in accordance with the invention have tube diameters in the range from 5 mm to 500 mm, preferably in the range from 8 mm to 200 mm and more preferably in the range from 10 mm to 100 mm. Alternatively, it is also possible in accordance with the invention to use flat channels which are comparable to plate apparatuses and have inlaid mixing structures. They have heights in the range from 1 mm to 20 mm and widths in the range from 10 mm to 1000 mm and especially in the range from 10 mm to 500 mm. Optionally, the tubular reactors may comprise mixing elements permeated by temperature control channels.

The optimal characteristic dimension is calculated here from the demands on the permissible anisothermicity of the reaction regime, the maximum permissible pressure drop and the propensity to blockage of the reactor.

Particularly preferred milli-reactors are:
tubular reactors composed of capillaries, capillary bundles with tube cross sections of 0.1 to 25 mm, preferably of 0.5 to 6 mm, more preferably of 0.7 to 4 mm, with or without additional mixing internals, it being possible for a temperature control medium to flow around the tubes or capillaries;
tubular reactors in which the heat carrier is conducted within the capillaries/tubes and the product whose temperature is to be controlled is conducted around the tubes and homogenized by internals (mixing elements);
plate reactors designed like plate heat exchangers with insulated parallel channels, networks of channels or areas equipped or not equipped with flow-disrupting internals (posts), the plates guiding product and heat carrier in parallel or in a layer structure having alternating heat carrier and product layers, such that chemical and thermal homogeneity can be ensured during the reaction; and
reactors with “flat” channel structures which have a “milli-dimension” only in terms of height and may have virtually any width, wherein the typical comb-shaped internals prevent the formation of flow profile and lead to a narrow residence time distribution which is important for the defined reaction regime and residence time.

In a preferred embodiment of the invention, at least one reactor which substantially has the residence time characteristics of plug flow is used. If plug flow is present in a tubular reactor, the state of the reaction mixture (e.g. temperature, composition etc.) may vary in flow direction, but the state of the reaction mixture is the same for each individual cross section at right angles to flow direction. Thus, all volume elements which enter the tube have the same residence time in the reactor. Viewed pictorially, the liquid flows through the tube as if it were a series of plugs sliding easily through the tube. In addition, the cross-mixing can balance out the concentration gradient at right angles to the flow direction through the intensified mass transfer at right angles to the flow direction.

In spite of the usually laminar flow through apparatuses having microstructures, it is thus possible to avoid backmixing and achieve a narrow residence time distribution, similarly to the case of ideal flow tube.

The Bodenstein number is a dimensionless characteristic and describes the ratio of convection flow to dispersion flow (e.g. M. Baerns, H. Hofmann, A. Renken, Chemische Reaktionstechnik [Chemical Reaction Technology], Lehrbuch der Technischen Chemie [Textbook of Industrial Chemistry], volume 1, 2^{nd} edition, p. 332 ff). It thus characterizes the backmixing within a system.

$$Bo = \frac{uL}{{D}_{ax}}$$

where u is the flow rate [ms−¹], L is the length of reactor [m] and Dₐₓ is the axial coefficient of dispersion [m²h⁻¹].

A Bodenstein number of zero corresponds to full backmixing in an ideal continuous stirred tank. An infinitely large Bodenstein number, in contrast, means absolutely no backmixing, as in the case of continuous flow through an ideal flow tube.

In capillary reactors, the desired backmixing characteristics can be established by adjusting the ratio of length to diameter as a function of the substance parameters and the flow state. The underlying calculation methods are known to those skilled in the art (e.g. M. Baerns, H. Hofmann, A. Renken: Chemische Reaktionstechnik, Lehrbuch der Technischen Chemie, volume 1, 2^{nd} edition, p. 339 ff). If minimum backmixing characteristics are to be implemented, the above-defined Bodenstein number selected is preferably greater than 10, more preferably greater than 20 and especially greater than 50. For a Bodenstein number of greater than 100, the capillary reactor then substantially has plug flow character.

Advantageous materials for the mixers and reactors to be used in accordance with the invention have been found to be stainless steels which are austenitic in the region of low temperatures, such as 1.4541 and 1.4571, generally known as V4A and as V2A respectively, and stainless steels of US types SS316 and SS317Ti. At relatively high temperatures and under corrosive conditions, polyether ketones are likewise suitable. However, it is also possible to use more corrosion-resistant Hastelloy® types, glass or ceramic as materials and/or corresponding coatings, for example TiN3, Ni-PTFE, Ni-PFA or the like for the reactors to be used in accordance with the invention.

The reactors are constructed such that the heat transfer areas are in very good contact with a temperature control medium, such that very good heat transfer is possible between the reaction mixture in the reaction zone and the temperature control medium, such that a substantially isothermal reaction regime is possible.

The temperature control medium should have sufficiently high heat capacity, should be circulated intensively and should be provided with a thermostat unit of sufficient power, and the heat transfer between the reaction zone and the temperature control medium should be as good as possible, in order to ensure a very substantially homogenous temperature distribution in the reaction zone.

For this purpose—according to the exothermicity and characteristic reaction time of the polymerization reaction—the ratio of heat exchange area to reaction volume should generally be between about 50 and about 5000 m²/m³, preferably between about 100 and about 3000 m²/m³, more preferably between about 150 and about 2000 m²/m³ and especially between about 200 and about 1300 m²/m³. Typically, the values for reactors having production capacities of about 5000 tonnes per year are in the region of about 200 m²/m³, for reactors having production capacities of about 500 tonnes per year in the region of about 500 m²/m³, and for reactors under the laboratory scale about 600 to 1300 m²/m³. In addition, the heat transfer coefficient on the part of the reaction medium should generally be more than 50 W/m²K, preferably more than 100 W/m²K, more preferably more than 200 W/m²K and especially more than 400 W/m²K.

More particularly, the process according to the invention is suitable for industrial production of polyisobutene derivatives in continuous and/or batchwise mode. In batchwise mode, this means batch sizes of more than 10 kg, better >100 kg, even more optimally >1000 kg or >5000 kg. In continuous mode, this means production volumes of more than 100 kg/day, better >1000 kg/day, even more optimally >10 t/day or >100 t/day.

The isobutene polymers prepared by the process according to the invention have a narrow molecular weight distribution. The polydispersity index PDI=M_{w}/Mₙ is usually below 2.0, preferably below 1.60, more preferably below 1.40 and especially below 1.3. More particularly, the polymers prepared in accordance with the invention have a low level of high molecular weight by-products, which also becomes clear from a low ratio of M_{z}/Mₙ, which is usually below 2.0, preferably below 1.60, more preferably below 1.40 and especially below 1.20. (Test method for molecular weights: see examples.)

Preference is given to using the process according to the invention for preparation of polyisobutenes having a number-average molecular weight Mₙ of 200 to 100 000, more preferably of 800 to 50 000 and especially of 1500 to 15 000.

The process is particularly suitable for high molecular weight polyisobutenes, i.e. polyisobutenes having a number-average molecular weight Mn greater than 800, better greater than 3500, even better greater than 5000 or greater than 7000 and preferably greater than 12 000.

The functionality (based on the optionally derivatized, terminal phenol groups) is preferably at least 80%, more preferably at least 90% and especially preferably at least 95%.

The present invention further provides a polyisobutene terminated at at least one end of the molecule by a group of the formula (V)

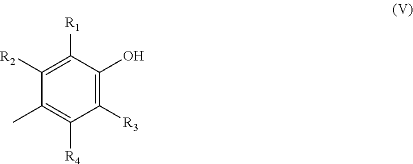

in which R₁, R₂, R₃, R₄ are each as defined above,
or a product thereof obtainable by
esterification, especially
i) acrylation,
etherification, especially
   ii) allylation or
   iii) reaction with epichlorohydrin,
   iv) reduction to the cyclohexanol system with the end groups VI

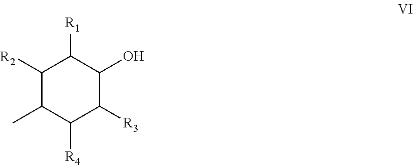

in which R₁, R₂, R₃, R₄ are each as defined above.

In order to further modify the polyisobutenes terminated by a phenol derivative, in one embodiment, the OH group of the phenol is activated. Suitable activation reagents are strong bases which convert the OH function to the phenoxide. Suitable reagents are, for example, sodium hydride, lithium hydride, potassium hydride, n-butyllithium, sec-butyllithium, isobutyllithium, tert-butyllithium, hexyllithium, methyllithium, sodium ethoxide, sodium butoxide, sodium amide, lithium diisopropylamide, or elemental sodium or potassium. These bases are used in solid form without solvents or as a solution or suspension with solvent. Suitable solvents are, for example, tetrahydrofuran, benzene, diethyl ether, paraffin oil.

Further suitable strong bases are, for example, sodium hydroxide, potassium hydroxide, calcium hydroxide, sodium carbonate. These bases are used in solid form or as an aqueous solution. Additionally with the aqueous system, phase transfer catalysts are used. Suitable catalysts are selected from the group of cations consisting of, for example, tetrabutylammonium, trimethyldodecylammonium, methyltrioctylammonium, heptyltributylammonium, tetrapropylammonium, tetrahexylammonium, tetraoctylammonium, tetradecylammonium, tetradodecylammonum, tetrabutylphosphonium, dodecyltrimethyiphosphonium, and selected from the group of anions consisting of chloride, bromide, sulfates, hydrogensulfates, phosphates, hydrogenphosphates.

### i) Acrylation

Acrylation is understood to mean esterification with (meth)acrylic acid. For functionalization with (meth)acrylate, a polyisobutene having OH termination prepared by the process according to the invention, or in activated form, can be reacted with a (meth)acrylate derivative. Suitable (meth)acrylates are, for example, acryloyl chloride, acryloyl bromide, acrylic acid, methacryloyl chloride, methacryloyl bromide, methacrylic acid. The reaction takes place within the range from −40° C. to 140° C., preferably in the range of −5° C. to 120° C.

The acrylation is preferably performed by transesterification. Phenol-terminated polyisobutene is reacted with a (meth)acrylate ester. Suitable (meth)acrylate esters are, for example, methyl acrylate, ethyl acrylate, propyl acrylate, butyl acrylate, phenyl acrylate, methyl methacrylate, ethyl methacrylate, propyl methacrylate, butyl methacrylate, phenyl methacrylate. The water which forms in the transesterification is removed continuously. The separation is effected with a standard distillation, or the water is discharged with the aid of another solvent, for example toluene.

### ii) Allylation

For functionalization with allyl groups, a polyisobutene with OH termination prepared by the process according to the invention, or in activated form, can be reacted with a functionalized allyl derivative. Suitable derivatives are, for example, allyl chloride, allyl bromide, allyl iodide, methallyl chloride, 4-chloromethylstyrene, chloroprene.

In a further embodiment, the polyisobutene functionalized with an allyl group is oxidized further and an epoxy group is incorporated. The oxidation is normally performed with peroxide. Suitable peroxides are, for example, hydrogen peroxide, p-chlorobenzoyl peroxide. The oxidation is performed within the temperature range from 0 to 150° C., depending on the peroxide used. Suitable solvents are hydrophobic alkanes, aromatic compounds, oils, or halide-containing solvents, for example hexane, heptane, paraffin oil, toluene, butyl chloride, or mixtures thereof. The oxidation is performed without or in the presence of further additives, catalysts, for example formic acid, sodium hydrogencarbonate or iron sulfate.

iii) Reaction with Epichlorohydrin

In a further embodiment, an epoxy-functionalized polyisobutene can be prepared directly with epichlorohydrin from a preferably activated polyisobutene prepared by the process according to the invention.

The reaction temperature in the reaction is within a range from 0° C. to 150° C. Normally, in reactions i-iii, standard pressure is employed; in specific embodiments, a vacuum between 1 mbar absolute and standard pressure, for example about 5, about 50 or about 500 mbar absolute, is advantageous. In a further embodiment, the reaction proceeds at elevated pressures, for example in the range from about 1.5 to about 20 bar.

These reactions can also take place in the presence of an auxiliary base which binds the hydrohalic acid released. Examples are tertiary bases such as triethylamine or DABCO, basic aromatics such as pyridine, or inorganic bases.

### iv) Reduction to the Cyclohexanol System,

The reduction of phenol-terminated polyisobutenes is described in WO06119931 A1, which is fully incorporated by reference.

In addition, the invention also relates to functionalization products of the inventive polyisobutyl-substituted cyclohexanols of the formula (VI), obtainable by reaction of the polyisobutyl-substituted cyclohexanols (VI)
a) with an olefinically unsaturated mono- or dicarboxylic acid or a derivative thereof and optional subsequent polymerization of the olefinically unsaturated product formed; or reaction with the polymer of an olefinically unsaturated mono- or dicarboxylic acid or a derivative thereof; or
(b) with an allyl halide and optionally subsequent polymerization of the allyl ether formed; or
(c) with an alkylene oxide; or
(d) with an isocyanate, a diisocyanate or a triisocyanate; or
(e) with a carbonic acid derivative or with saturated or aromatic dicarboxylic acids and derivatives thereof; or
(f) with ammonia or an amine NR′R″, where R′ is a C₁-C₂₄-alkyl radical and R″ is a C₁-C₂₄-alkyl radical or H.

With regard to the execution of these reactions, reference is made to WO06119931 A1.

In addition, the invention also relates to a process as described above for preparing functionalized polyisobutenes, wherein one or more of the terminal phenol groups are derivatized by ethoxylation. The invention also relates to polyisobutene-polyethylene oxide block copolymers obtainable by this process.

Phenol-terminated polyisobutene prepared in accordance with the invention can be ethoxylated, and it is possible to prepare, from a polyisobutylenes activated by a phenol group and prepared by the process according to the invention, to polyisobutene-polyethylene oxide block copolymers.

For example, the phenol-terminated polyisobutene can be activated with aqueous basic solution (e.g. alkali metal hydroxide solution, KOH solution) and the mixture can be dewatered at elevated temperature, for example at at least 100° C., under reduced pressure. The ethoxylation takes place in the course of heating (for example to 100-150° C.) and under pressure (for example at least 1 bar) with preferably continuous metered addition of ethylene oxide. The basic crude product is neutralized with suitable acids (e.g. acetic acid) or with silicates and filtered off. Alternatively, the ethoxylation, rather than with basic solution (KOH solution), can be conducted with the aid of double metal cyanide (DMC) catalyst under otherwise the same conditions.

The desired length of the polyethylene block in the block copolymers is calculated from the ratio of phenol-terminated polyisobutene and ethylene oxide.

The length of the polyethylene block (the ethoxylation level) may, for example, be 1 to 300, preferably from 3 to 200.

The examples which follow are intended to illustrate the invention in detail.

### EXAMPLES

### Example 1

### Polymerization of Isobutene and In Situ Termination with Phenol

500 ml of chlorobutane and 150 ml (1.59 mol) of isobutene were titrated under anhydrous conditions with butyllithium and distilled under nitrogen in a 1 l reaction flask equipped with a dropping funnel. 15 g (100 mmol) of C8 chloride were added and the mixture was cooled to −78° C. The polymerization was started with the addition of 3 ml of titanium tetrachloride. The temperature rose immediately to −27° C. The polymer mixture was stirred at −78° C. for another 60 minutes. 46.5 g (0.495 mol) of phenol were dissolved in 150 ml of chlorobutane and 4 g (30 mmol) of aluminum trichloride were added. After 10 minutes, a pale yellowish, clear solution was obtained. The phenol solution was added dropwise to the solution of polyisobutene at 2° C. within 10 minutes and the mixture was warmed to RT and diluted with 1 l of hexane. The solution is washed three times with methanol/water (80/20) mixture and the hexane phase dried over sodium sulfate, filtered and concentrated by rotary evaporation at 120° C./10 mbar.

Final weight: 104 g of phenol-functionalized polyisobutene.

GPC analysis (polystyrene standard, result converted to polyisobutene, ERC-RI-101 detector, tetrahydrofuran eluent, flow rate: 1200 ml/min): Mn=10 530 g/mol,

Mw=13 200 g/mol, Mz=16 600 g/mol, PDI=1.29

¹H FT NMR (500 MHz, 16 scans, CD₂Cl₂) of the allyl groups in polyisobutene

Aromatic starter in polymer: 7.38 ppm, 1H, s; 7.15 ppm, 3H, mp; phenol functionalization: 7.22 ppm, 2H, d; 6.74 ppm, 2H, d.

### Example 2

### Continuous Polymerization of Isobutene and In Situ Termination with Phenol in a Milli-Reactor

Liquid isobutene (3.57 mol/h) was mixed continuously with a solution of C8 chloride (2.63 mol/h), phenyltriethoxysilane (10 mmol/h) and 1,3-dicumyl chloride (18 mmol/h) in a micro-mixer, and subsequently mixed homogeneously with a solution of C8 chloride (2.62 mol/h) and TiCl₄ (39 mmol/h) in a second micro-mixer at reaction temperature. The reaction solution formed was subsequently pumped through a temperature-controlled reaction capillary made of Hastelloy (internal diameter 4 mm, length 27 m) with a defined, constant flow rate of 700 g/h. In a third micro-mixer, the polymer solution formed was mixed continuously at ambient temperature with a mixture of phenol (0.5 mol/h), C8 chloride (4.32 mol/h) and aluminum trichloride (50.2 mmol/h) and supplied to a 2 l reaction flask for 30 min. After stirring at room temperature for 2 hours, the reaction was terminated with addition of methanol and the product was worked up and analyzed analogously to the experiments in the batch (example 1).

GPC analysis (polystyrene standard, result converted to polyisobutene, ERC-RI-101 detector, tetrahydrofuran eluent, flow rate: 1200 ml/min): Mn=9970 g/mol,

Mw=12 500 g/mol, Mz=15 700 g/mol, PDI=1.25

¹H FT NMR (500 MHz, 16 scans, CD₂Cl₂) of the allyl groups in polyisobutene

Aromatic starter in polymer: 7.38 ppm, 1H, s; 7.15 ppm, 3H, mp; phenol functionalization: 7.22 ppm, 2H, d; 6.74 ppm, 2H, d.

### Example 3

### Reaction of PIB10 000-Bisphenol with Allyl Bromide

50 g of PIB10 000-bisphenol (phenol-terminated PIB with Mn of about 10 000, obtainable according to example 1 or 2) and 0.2 g of cetyltrimethylammonium bromide were dissolved at ambient temperature in 100 g of chlorobutane. At ambient temperature, 25 ml of sodium hydroxide solution (2N solution) were added dropwise within 1 minute, and the mixture was heated to 60° C. and stirred at 60° C. for 2 hours. At ambient temperature, 1 g of allyl bromide was added dropwise via a septum/syringe within 1 min and the temperature was raised to 80° C. and the mixture was stirred at this temperature for 5 hours. After cooling, the product mixture was diluted with 250 ml of hexane and washed with 200 ml of water and then twice with 200 ml of methanol and once again with 200 ml of water, dried with Na₂SO₄ and filtered through a fluted filter. The clear product phase was concentrated on a rotary evaporator at 120° C. and 7 mbar. Yield: 39 g, light-colored, clear and viscous liquid.

¹H FT NMR (500 MHz, 16 scans, CD₂Cl₂) of the allyl group in polyisobutene 4.49 ppm, 2H, d; 5.25 ppm, 1H, dd; 5.39 ppm, 1H, dd; 6.05 ppm, 1H, multiplet.

### Example 4

### Reaction of PIB10 000-Bisphenol with Acryloyl Chloride

50 g of PIB10 000-bisphenol (phenol-terminated PIB with Mn of about 10 000, obtainable according to example 1 or 2) and 0.2 g of cetyltrimethylammonium bromide were dissolved at ambient temperature in 100 g of chlorobutane. At ambient temperature, 25 ml of sodium hydroxide solution (2N solution) were added dropwise within 1 minute, and the mixture was heated to 60° C. and stirred at 60° C. for 2 hours. At ambient temperature, 1 g of acryloyl chloride was added dropwise via a septum/syringe within 1 min and the temperature was raised to 80° C. and the mixture was stirred at this temperature for 1 hour. After cooling, the product mixture was diluted with 250 ml of hexane and washed with 200 ml of water and then twice with 200 ml of methanol and once again with 200 ml of water, dried with Na₂SO₄ and filtered through a fluted filter. The clear product phase was concentrated on a rotary evaporator at 120° C. and 7 mbar. Yield: 41 g, light-colored, clear and viscous liquid.

¹H FT NMR (500 MHz, 16 scans, CD₂Cl₂) of the allyl group in polyisobutene 5.97 ppm, 1H, d; 6.30 ppm, 1H, dd; 6.54 ppm, 1H, d.

### Example 5

### Ethoxylation

275 g of phenol-terminated polyisobutene having Mw 5500 g/mol is activated with one equivalent of aqueous 50% KOH solution in a 2 l autoclave and the mixture is dewatered at 100° C. at 20 mbar for two hours. Subsequently, the autoclave is purged three times with nitrogen, a supply pressure of 1.3 bar N₂ is established and the temperature is increased to 120° C. The ethoxylation takes place under this pressure, with the temperature kept between 120 and 140° C. and with metered addition of 6.25 mol of ethylene oxide (corresponding to an ethoxylation level of 125 and an MW of 5500 g/mol for the PEO block). Thereafter, the mixture is stirred between 120 and 140° C. for five hours, purged with nitrogen and cooled to room temperature. The mixture is neutralized with acetic acid and the product is analyzed by NMR and GPC.

1. A process for preparing a functionalized polyisobutene, the process comprising:
polymerizing isobutene or an isobutene-comprising monomer mixture in the presence of a Lewis acid and an initiator,
terminating said polymerizing with a mixture of at least one phenol and at least one Lewis acid and/or at least one Brønsted acid, and
optionally derivatizing or reducing the terminal phenol groups to cyclohexanol systems.

2. The process according to claim 1, wherein the polyisobutene has a functionality of at least 80% and a number-average molecular weight Mn of greater than 5000.

3. The process according to claim 1, wherein the at least one terminal phenol group is esterified or etherified.

4. The process according to claim 3, wherein the at least one terminal phenol group is esterified with (meth)acrylic acid or etherified with a glycidyl alcohol.

5. The process according to claim 1, wherein the Lewis acid is selected from the group consisting of titanium tetrachloride, boron trichloride, tin tetrachloride, aluminum trichloride, a dialkylaluminum chloride, an alkylaluminum dichloride, vanadium pentachloride, iron trichloride and boron trifluoride.

6. The process according to claim 1, wherein the initiator has a formula of formulae I-A to I-F: 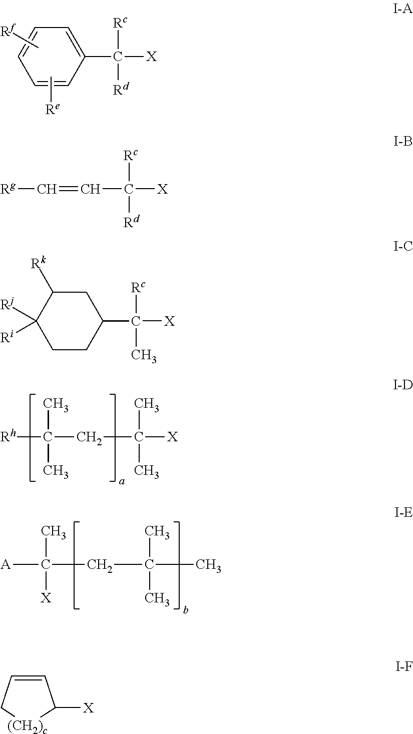
wherein
X is halogen, a C₁-C₆-alkoxy, or a C₁-C₆-acyloxy;
a and b are each independently 0, 1, 2, 3, 4 or 5;
c is 1, 2 or 3;
R^{c}, R^{d} and R^{j} are each independently hydrogen or methyl;
R^{e}, R^{f} and R^{g} are each independently hydrogen, a C₁-C₄-alkyl or a CR^{c}R^{d}—X group where R^{c}, R^{d} and X are defined above;
R^{h} is hydrogen, methyl or an X group;
Rⁱ and R^{k} are each hydrogen or an X group; and
A is an ethylenically unsaturated hydrocarbonyl radical comprising a vinyl group or a cycloalkenyl group.

7. The process according to claim 1, wherein the polymerization is effected in the presence of an electron donor selected from the group consisting of a pyridine, an amide, a lactam, an ether, an amine, an ester, a thioether, a sulfoxide, a nitrile, a phosphine, and a nonpolymerizable aprotic organosilicon compound comprising at least one organic radical bonded via oxygen.

8. The process according to claim 1, wherein said terminating occurs in the presence of a phenol of formula (I) 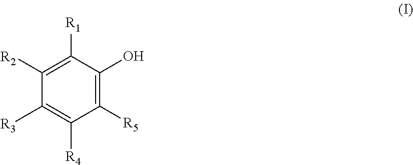
where R₁, R₂, R₃, R₄, R₅ are each independently a radical of hydrogen, an alkyl or an alkoxy, with the proviso that at least one radical in an ortho or paraposition is hydrogen.

9. The process according to claim 1, wherein the Lewis acid in said terminating is selected from the group consisting of BF₃, BCl₃, SnCl₄, TiCl₄, AlCl₃ and a mixture thereof.

10. The process according to claim 1, wherein said polymerizing is performed in a continuous process comprising:
(I) adding reactants isobutene, solvent, initiator and optionally further reactants to a mixer in a continuous metered manner and mixing the reactants in the mixer, and
(II) starting a continuous polymerization by a continuous metered addition of a Lewis acid and mixing with the reactants at a reaction temperature, and
(III) continuously polymerizing the reactants by passing a resulting reaction mixture through at least one reaction zone under reaction conditions, and
(IV) terminating the polymerization via a mixture of at least one phenol and at least one Lewis acid and/or at least one Brønsted acid.

11. The process according to claim 1, which comprises said derivatizing or said reducing,
wherein said derivatizing occurs by derivatizing the at least one terminal phenol group by
i) acrylation,
ii) allylation, with optional oxidation of an allyl group to an epoxide, or
iii) reaction with epichlorohydrin.

12. The process according to claim 11, which comprises said reducing,
wherein the at least one phenol group reduced to the cyclohexanol system has been further functionalized by reaction of at least one polyisobutyl-substituted cyclohexanol
a) with an olefinically unsaturated mono- or dicarboxylic acid or a derivative thereof and optional subsequent polymerization of an olefinically unsaturated product formed; or reaction with a polymer of an olefinically unsaturated mono- or dicarboxylic acid or a derivative thereof;
(b) with an allyl halide and optionally subsequent polymerization of an allyl ether formed;
(c) with an alkylene oxide;
(d) with an isocyanate, a diisocyanate or a triisocyanate;
(e) with a carbonic acid derivative or a saturated or aromatic dicarboxylic acid and a derivative thereof; or
(f) with ammonia or an amine NR′R″, where R′ is a C₁-C₂₄-alkyl radical and R″ is a C₁-C₂₄-alkyl radical or H.

13. A polyisobutene obtained from the process according to claim 1.

14. A process for producing an adhesive, an adhesive raw material, a fuel additive, or a lubricant additive, the process comprising:
introducing a polyisobutene obtained from the process according to claim 1 into the adhesive, the adhesive raw material, the fuel additive, or the lubricant additive as an elastomer or as a base constituent of a sealing compound.

15. The process according to claim 1, wherein the at least one terminal phenol group is derivatized by ethoxylation.

16. A polyisobutene-polyethylene oxide block copolymer obtained by the process according to claim 15.
